(19) United States
(12) Patent Application Publication
(10) Pub. No.: US 2012/0268457 A1
(43) Pub. Date: Oct. 25, 2012

(54) INFORMATION PROCESSING APPARATUS, INFORMATION PROCESSING METHOD AND PROGRAM STORAGE MEDIUM

(76) Inventor: Yuuichiro Aso, Hamura-shi (JP)

(21) Appl. No.: 13/407,473

(22) Filed: Feb. 28, 2012

(30) Foreign Application Priority Data
Apr. 19, 2011 (JP) 2011-093416

(51) Int. Cl. G06T 15/00

(52) U.S. Cl. 345/419

(57) ABSTRACT

According to one embodiment, an information processing apparatus includes a display module, a detector, and a display controller. The display module three-dimensionally displays an image in a first region of a display screen and displays information in a second region of the display screen, the display screen capable to switch two-dimensional display and three-dimensional display. The detector detects overlapping between at least part of the first region and the second region. The display controller two-dimensionally displays the image in the first region if the detector detects the overlapping.

### CROSS-REFERENCE TO RELATED APPLICATIONS

This application is based upon and claims the benefit of priority from prior Japanese Patent Application No. 2011-093416, filed Apr. 19, 2011, the entire contents of which are incorporated herein by reference.

### FIELD

Embodiments described herein relate generally to an information processing apparatus, information processing method and program storage medium for displaying a three-dimensional image.

### BACKGROUND

Recently, various image display devices that enable enjoyment of three-dimensional images are provided. As one of the above image display devices, an image display device of a naked-eye stereoscopic display system is provided. For example, in the naked-eye stereoscopic display system, left-eye and right-eye images are simultaneously displayed on a liquid crystal display (LCD) (space division system) and the directions in which light rays corresponding to pixels in the image are emitted are controlled by means of a vertical lenticular lens arranged on the LCD (lenticular system). As a result, since the user can view pixels of the left-eye image with a left eye and pixels of the right-eye image with a right eye, the user can view a three-dimensional image (stereoscopic image).

As one example of the three-dimensional image, there is an image recorded on an optical disk such as a DVD and Blu-ray disk (registered trademark). The optical disk can be reproduced not only by means of a reproduce apparatus or record/reproduce apparatus but also by means of a personal computer having a disk reproduce program installed therein. In the case of playback by means of a reproduce apparatus, a three-dimensional image read from the optical disk is displayed on the entire portion of a screen of an LCD. However, on some of the optical disks, no three-dimensional image may be recorded and only a two-dimensional image may be recorded. Therefore, the lenticular lens arranged on the LCD may be configured by a liquid crystal gradient index lens that can electrically switch a lens function required for three-dimensional image display (a lens that creates refractive index distribution by means of electrodes by using a flat liquid crystal) and thus the three-dimensional image display and two-dimensional image display can be switched.

On the other hand, when the optical disk is reproduced by means of a personal computer, a window for a reproduce program may be displayed on a part of the screen of the LCD, three-dimensional image display may be made in the window and two-dimensional image display may be made in a desk-top screen other than the window or in a different window. Therefore, the liquid crystal gradient index lens can be designed to change the position and the size of a three-dimensional image display region by partly controlling the electrodes.

When the three-dimensional image display is made by using the reproduce program of the personal computer and if the operation of displaying a menu screen of the reproduce program is performed or another application program is started, another window is displayed on the screen. The other window may be displayed to overlap the three-dimensional image display window depending on the position and the size of a three-dimensional image display window. Alternatively, the windows are not first overlapped, but the other window may overlap the three-dimensional image display window if the user performs the operation of moving the position of the other window or changing the size thereof. The three-dimensional image display window that comes under the other different window is partly eliminated in the left-eye and right-eye images. In the naked-eye stereoscopic display system, it is necessary to view pixels of a left-eye image with the left eye and pixels of a right-eye image with the right eye. Therefore, in such a case, a stereoscopic image cannot be displayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing one example of the appearance of an image processing apparatus of an embodiment.

FIG. 2 is an exemplary block diagram showing one example of the configuration of the image processing apparatus of the embodiment.

FIG. 3 is an exemplary block diagram showing one example of the configuration of an image content reproduce program of the image processing apparatus of the embodiment.

FIG. 4 is an exemplary flowchart for illustrating one example of a process of the image processing apparatus of the embodiment.

FIGS. 5A, 5B, and 5C are exemplary views showing the concept of a process when the image content reproduce program reads a two-dimensional image.

FIGS. 6A, 6B, and 6C are exemplary views showing the concept of a process when the image content reproduce program reads a three-dimensional image.

FIGS. 7A, 7B, and 7C are exemplary views showing the concept of a process when the image content reproduce program reads another three-dimensional image.

FIGS. 8A, 8B, and 8C are exemplary views showing the concept of one example of a process of the image content reproduce program when another window is overlapped on a three-dimensional image display window.

FIGS. 9A, 9B, and 9C are exemplary views showing the concept of another example of a process of the image content reproduce program when another window is overlapped on a three-dimensional image display window.

### DETAILED DESCRIPTION

Various embodiments will be described hereinafter with reference to the accompanying drawings.

In general, according to one embodiment, an information processing apparatus includes a display module, a detector, and a display controller. The display module three-dimensionally displays an image in a first region of a display screen and displays information in a second region of the display screen, the display screen capable to switch two-dimensional display and three-dimensional display. The detector detects overlapping between at least part of the first region and the second region. The display controller two-dimensionally displays the image in the first region if the detector detects the overlapping.

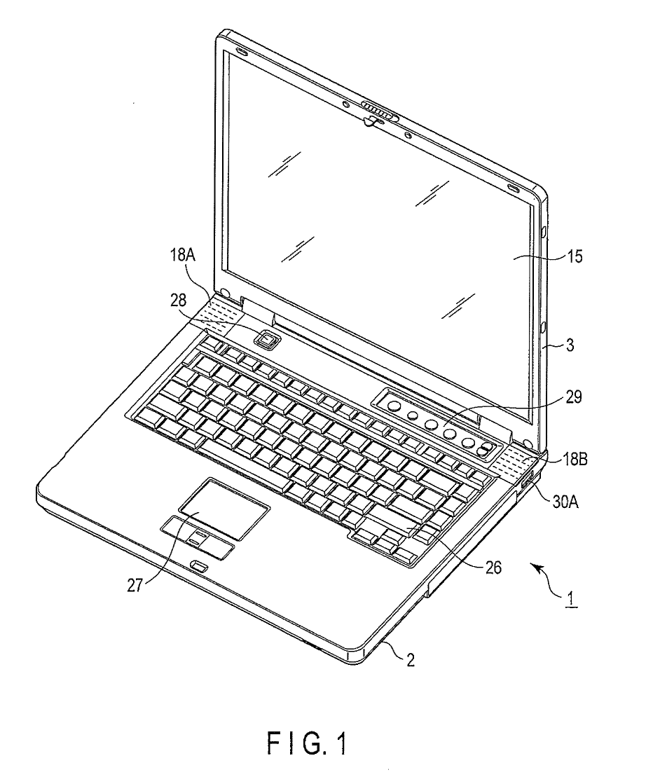

FIG. 1 is an exemplary perspective view showing the appearance of an image processing apparatus of an embodiment. For example, the image processing apparatus is realized as a notebook personal computer (PC) 1. However, the image processing apparatus can be realized as another device, for example, a television receiver, a recorder that stores image data (for example, hard disk recorder, DVD recorder), tablet type PC, slate type PC, personal digital assistance (FDA), car navigation device, smart phone or the like.

As shown in FIG. 1, the PC 1 includes a computer main body 2 and display unit 3.

In the display unit 3, a three-dimensional display 15 is incorporated. The display unit 3 is mounted on the computer main body 2 to freely move between an open position in which the upper surface of the computer main body 2 is exposed and a closed position in which it covers the upper surface of the computer main body 2. The three-dimensional display 15 includes an LCD (liquid crystal display) 15A and lens unit 15B.

The principle of three-dimensional image display is based on a naked-eye stereoscopic display system in which a stereoscopic image can be viewed without using exclusive glasses by simultaneously displaying a plurality of images whose positions and angles are different according to viewing positions and capturing different images by left and right eyes of the viewer. Therefore, a plurality of images having a plurality of parallaxes are simultaneously drawn on the LCD 15A, images in plural directions are displayed by using one pixel and the light of the pixel is radiated in plural directions by using the lens unit 15B having a vertical lenticular lens function.

The lens unit 15B configured by a flat liquid crystal layer is attached to the LCD 15A. For example, the lens unit 15B is a liquid crystal gradient index (GRIN) lens that can electrically switch functions required for three-dimensional image display. Since refractive index distribution is created based on a voltage applied to the electrode, for example, the liquid crystal GRIN lens can make three-dimensional image display in a region in the screen and make two-dimensional image display in another region. That is, a three-dimensional display mode for three-dimensional display and a two-dimensional display mode for two-dimensional display can be partially switched in the screen of the three-dimensional display 15 by changing the refractive index of the liquid crystal GRIN lens in the three-dimensional image display region and two-dimensional image display region. The positions and sizes of the three-dimensional image display region and two-dimensional image display region can be freely set. In a region set in the three-dimensional image display mode, the refractive index is controlled to cause an image viewed by the left eye and an image viewed by the right eye displayed in the above region to have parallax according to an eye-eye distance and viewing distance. In a region set in the two-dimensional image display mode, the refractive index is controlled to cause an image to be displayed in the above region as it is without being refracted. Thus, in the three-dimensional display 15, each of a plurality of regions set in the screen and having desired positions and sizes can be selectively set to one of the three-dimensional display mode and two-dimensional display mode.

The three-dimensional display 15 displays a synthesized image (also referred to as parallax image data) configured by left-eye and right-eye images in the region of the three-dimensional display mode and displays a two-dimensional image in the region of the two-dimensional display mode. Therefore, the user can view perceive a three-dimensional image (stereoscopic image) when viewing the region set in the three-dimensional display mode in the screen and perceive a two-dimensional image when viewing the region set in the two-dimensional display mode.

The computer main body 2 has a thin box-shaped casing and a keyboard 26, a power-on button 28 used for turning on/off the power of the PC 1, an input operation panel 29, a pointing device (touchpad) 27, speakers 18A and 18B and the like are arranged on the upper surface thereof. Various operation buttons are provided on the input operation panel 29. The button group includes an operation button group used for controlling a TV function (content viewing, content recording, playback of recorded broadcasting content/video data), optical disk playback function and the like.

For example, on the right-side surface of the computer main body 2, an antenna terminal 30A for TV broadcasting is provided. Further, for example, on the back surface of the computer main body 2, an external display connection terminal corresponding to the high-definition multimedia interface (HDMI) standard is provided. The external display connection terminal is used for outputting image data (moving image data) included in image content such as broadcasting program data to an external display.

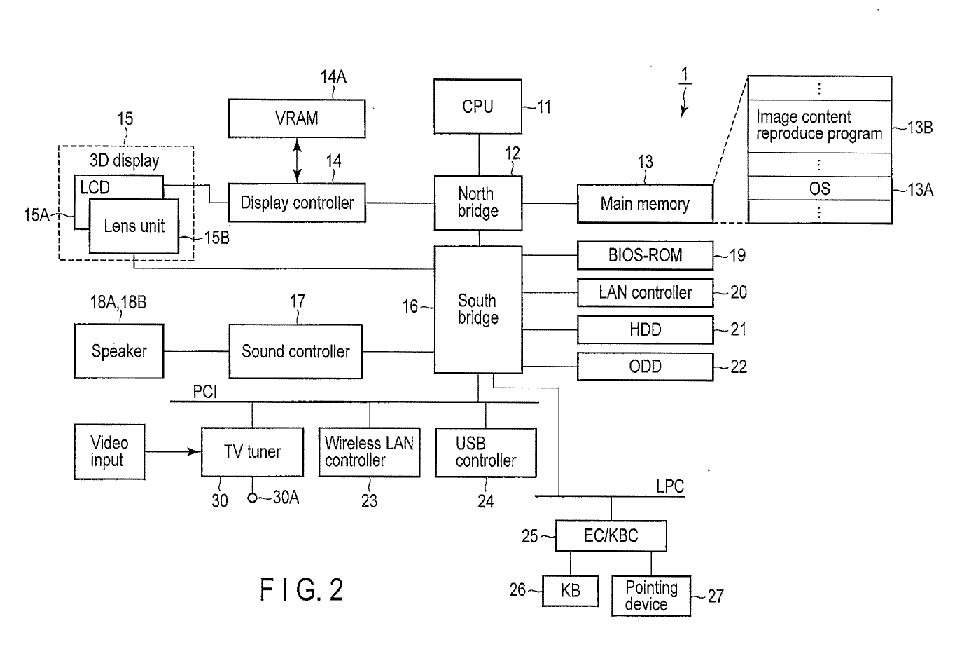

FIG. 2 is an exemplary diagram showing the system configuration of the PC 1.

As shown in FIG. 2, the PC 1 includes a CPU 11, north bridge 12, main memory 13, display controller 14, video memory (VRAM) 14A, three-dimensional display 15, south bridge 16, sound controller 17, speakers 18A and 18B, basic input/output system ROM (BIOS-ROM) 19, local area network (LAN) controller 20, hard disk drive (HDD) 21, optical disk drive (ODD) 22, wireless LAN controller 23, universal serial bus (USB) controller 24, embedded controller/keyboard controller (EC/KBC) 25, keyboard (KB) 26, pointing device 27, TV tuner 30 and the like.

The CPU 11 is a processor for controlling the operation of the PC 1. The CPU 11 executes an operating system (OS) 13A and application programs such as image content reproduce program 13B loaded from the HDD 21 to the main memory 13. The image content reproduce program 13B is software having a function of viewing image content. The image content reproduce program 13B performs a live reproduce process for viewing broadcasting program data received by the TV tuner 30, a recording process for recording received broadcasting program data on the HDD 21, a reproduce process for reproducing broadcasting program data/video data recorded on the HDD 21, a reproduce process for reproducing image content received via the network and the like. Further, the image content reproduce program 13B can reproduce image content stored in a storage medium such as an optical disk as represented by a DVD and a storage device such as a hard disk.

Further, the image content reproduce program 13B also has a function of viewing a three-dimensional image. The image content reproduce program 13B can convert a two-dimensional image included in image content to a three-dimensional image on a real-time basis (2D-3D conversion) to display the thus converted image on the screen (the screen of the three-dimensional display) 15. The image content reproduce program 13B can subject various image content (for example, broadcasting program data, video data stored in a storage medium or storage device, video data received from a server on the Internet and the like) to a 2D-3D conversion process.

Further, the image content reproduce program 13B has a message display control function of controlling display of a message provided for the user while he is viewing image content. For example, the message is a message, subtitles, closed caption, control panel for operations and the like used for notifying errors or statuses that are required to be displayed according to the OS 13A and various application programs such as image content reproduce program 13B.

Further, the CPU 11 also executes a BIOS stored in the BIOS-ROM 19. The BIOS is a program for hardware control.

The north bridge 12 is a bridge device that connects the local bus of the CPU 11 to the south bridge 16. The north bridge 12A includes a memory controller that controls access to the'main memory 13. Further, the north bridge 12 has a function of communicating with the display controller 14.

The display controller 14 is a device that controls the LCD 15 used as the display of the PC 1. A display signal created by the display controller 14 is transmitted to the LCD 15. The LCD 15 displays an image based on the display signal.

The south bridge 16 controls various devices on a peripheral component interconnect (PCI) bus and low pin count (LPC) bus. Further, the south bridge 16 includes an integrated drive electronics (IDE) controller for controlling the HDD 21 and ODD 22 and a memory controller for controlling access to the BIOS-ROM 19. Additionally, the south bridge 16 has a function of communicating with the sound controller 17 and LAN controller 20.

Further, the south bridge 16 can output a control signal used for selectively setting each of a plurality of regions in the lens unit 15B to one of the three-dimensional display mode and two-dimensional display mode according to a request by the image content reproduce program 13B to the lens unit 15B. The lens unit 15B selectively sets each of the regions to one of the three-dimensional display mode and two-dimensional display mode by, for example, changing the refractive indices of portions in the liquid crystal layer corresponding to the respective plural regions according to the control signal output from the south bridge 16. As a result, a window for displaying a three-dimensional image by the image content reproduce program 13B and a window (not limited to one) for displaying a two-dimensional image according to another application program can be set on the screen of the LCD 15. The operation of coping with a case where the windows are overlapped will be described later.

The sound controller 17 is a sound source device and outputs to-be-processed audio data to the speakers 18A and 18B. For example, the LAN controller 20 is a wired communication device that performs wired communication based on the Ethernet (registered trademark) standard and the wireless LAN controller 23 is a wireless communication device that performs wireless communication based on, for example, the IEEE 802.11 standard. Further, the USB controller 24 communicates with an external device via a cable of, for example, the USB2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of turning on/off the power of the PC 1 according to the operation by the user.

The TV tuner 30 is a receiver device that receives broadcasting program data broadcast by a television (TV) broadcasting signal and is connected to the antenna terminal 30A. For example, the TV tuner 30 is realized as a digital TV tuner that can receive digital broadcasting program data such as a terrestrial digital TV broadcast. Further, the TV tuner 30 has a function of capturing video data input from an external device.

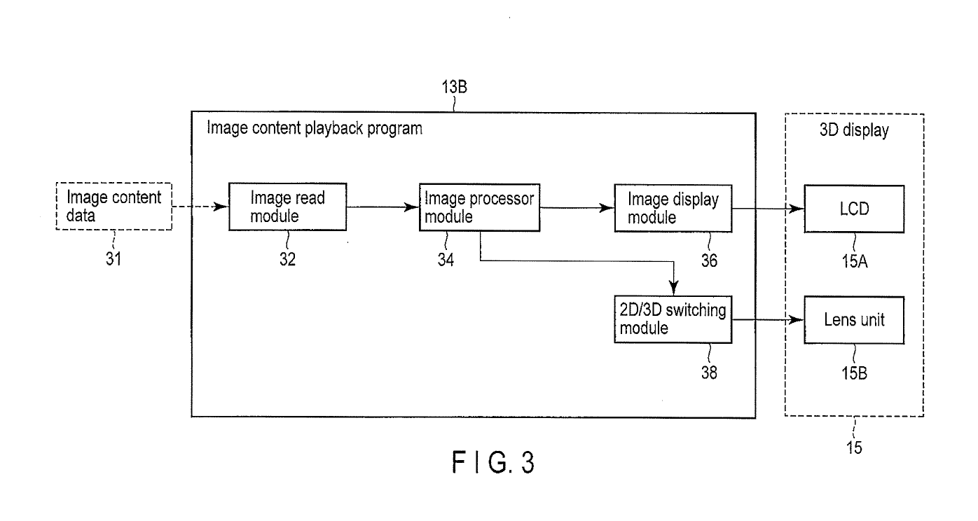

FIG. 3 is a block diagram showing an example of the functional configuration of the image content reproduce program 13B. The image content reproduce program 13B has an image reproduce function of reproducing image content data 31 as a two-dimensional image or three-dimensional image. The image content reproduce program 13B also has a message display control function of displaying various messages displayed in a period in which an image is reproduced to be easily viewed by the user.

When executed by the CPU 11, the image content reproduce program 13B realizes an image read module 32, image processor module 34, image display module 36 and 2D/3D mode switching module 38. The image read module 32, image processor module 34, image display module 36 and 2D/3D mode switching module 38 relate to an image reproduce function.

For example, the image read module 32 reads image content data 31 from a storage medium such as a DVD or a storage device such as the HDD 21. The image read module 32 can receive image content data 31 via the TV tuner 30, LAN controller 20, wireless LAN controller 23 and the like. The image content data 31 includes two-dimensional image data used for displaying a two-dimensional image and/or three-dimensional image data used for displaying a three-dimensional image. For example, the above image data items are compression-coded image data items (for example, MPEG-coded data). In this case, the image data is used after being decoded. The image content data 31 may include various meta-data items. The image read module 32 outputs the read (received) image content data 31 to the image processor module 34.

The image processor module 34 creates image data by using the image content data 31 output by the image read module 32. Specifically, the image processor module 34 first determines whether an image is displayed in the two-dimensional display mode or in the three-dimensional display mode. For example, when three-dimensional image data configured by right-eye and left-eye images is included in the image content data 31, the image processor module 34 determines that the image should be displayed in the three-dimensional display mode. When image content data read from a storage medium is reproduced, two-dimensional display and three-dimensional display may be specified with respect to the storage medium and mode specification information may be contained in the read signal. In such a case, the display mode is determined according to the mode specification information. Further, the image processor module 34 can determine that an image should be displayed in a display mode specified by the user. For example, the user can select a display mode by using an operation screen including a button used for selecting one of the two-dimensional and three-dimensional display modes. Further, the user can determine a region (window) for displaying image data. An initial value may be determined by default without determining a display region by the user. The size and position of the display region can be freely changed from the initial value.

When it is determined that an image is displayed in the three-dimensional display mode and three-dimensional image data is included in the image content data 31, the image processor module 34 processes the three-dimensional image data to become suitable for three-dimensional display. For example, when image content data read from a storage medium for three-dimensional content includes a left-eye image data stream and right-eye image data stream, the image processor module 34 rearranges pixels of left-eye image data and right-eye image data of each frame to create three-dimensional image (also referred to as a parallax image) data of one frame. Further, the storage medium for three-dimensional content may store three-dimensional image (parallax image) data of one frame having left-eye image data and right-eye image data arranged in the horizontal direction and output the same as one stream. In this case, the image processor module 34 uses data read from the storage medium as it is.

The image processor module 34 requests the 2D/3D switching module 38 to set the image display region in the three-dimensional display 15 to the three-dimensional display mode. Specifically, the image processor module 34 outputs information (coordinates or the like) indicating an image display region and information indicating that a specified region (that is, an image display region) is set to the three-dimensional display mode to the 2D/3D switching module 38. For example, the image display region is a window region for displaying an image based on the image content data 31. Further, the image processor module 34 outputs the created three-dimensional image data to the image display module 36.

When it is determined that an image is displayed in the three-dimensional display mode and three-dimensional image data is not included but two-dimensional image data is included in the image content data 31, the image processor module 34 subjects the two-dimensional image data to 2D-3D conversion. By 2D-3D conversion, a plurality of depth values corresponding to a plurality of pixels included in each image frame of the two-dimensional image are estimated and a plurality of parallaxes corresponding to a plurality of estimated depth values are calculated by taking binocular parallax, viewing distance and the like into consideration. That is, a plurality of parallaxes corresponding to a plurality of pixels included in the image frame are calculated. The image processor module 34 creates left-eye image data and right-eye image data based on the calculated parallax and rearranges pixels of left-eye image data and right-eye image data of each frame to create three-dimensional image (parallax image) data of one frame. The image processor module 34 requests the 2D/3D mode switching module 38 to set the image display region in the three-dimensional display 15 to the three-dimensional display mode. Then, the image processor module 34 outputs the created three-dimensional image data to the image display module 36.

Further, the image processor module 34 requests the 2D/3D mode switching module 38 to set the image display region in the three-dimensional display 15 to the two-dimensional display mode when it is determined that an image is displayed in the two-dimensional mode and that two-dimensional image data is included in the image content data 31. Then, the image processor module 34 outputs two-dimensional image data to the image display module 36.

The 2D/3D mode switching module 38 switches the display mode of the image display region in response to the request by the image processor module 34. Specifically, the 2D/3D mode switching module 38 sets a specified region to a specified display mode based on information output from the image processor module 34. For example, when it is requested to set the image display region to the three-dimensional display mode by means of the image processor module 34 and when the image display region has been set in the two-dimensional display mode, the 20/3D mode switching module 38 switches the image display region from the two-dimensional display mode to the three-dimensional display mode. Further, when it is requested to set the two-dimensional display mode by means of the image processor module 34 and if the image display region has been set in the three-dimensional display mode, the 2D/3D mode switching module 38 switches the image display region from the three-dimensional display mode to the two-dimensional display mode.

In the three-dimensional display mode, a portion corresponding to the image display region in the lens unit 15B is controlled to have a lens function (refractive index) required for three-dimensional display. In the two-dimensional display mode, a portion corresponding to the image display region in the lens unit 15B is controlled to have a lens function (that is, a two-dimensional image is displayed as it is without being polarized) required for two-dimensional display.

The image display module 36 displays an image in the image display region in the LCD 15A. Specifically, three-dimensional image (parallax image) data configured by left-eye and right-eye image data items is output by means of the image processor module 34, and the image display module 36 displays a three-dimensional image configured by left-eye and right-eye images in the image display region of the LCD 15A by using the three-dimensional image data. Further, when two-dimensional image data is output by means of the image processor module 34, the image display module 36 displays a two-dimensional image in the image display region of the LCD 15A by using two-dimensional image data.

With the configuration having the above image reproduce function, the user can enjoy a three-dimensional image or two-dimensional image displayed on the three-dimensional display 15 (image display region). When a three-dimensional image is displayed on the three-dimensional display 15, the light-emission directions of respective pixels in the left-eye and right-eye images displayed in the image display regions of the LCD 15A are controlled according to portions corresponding to the image display regions of the lens unit 15B. As a result, the user can stereoscopically perceive an image with naked eyes without glasses.

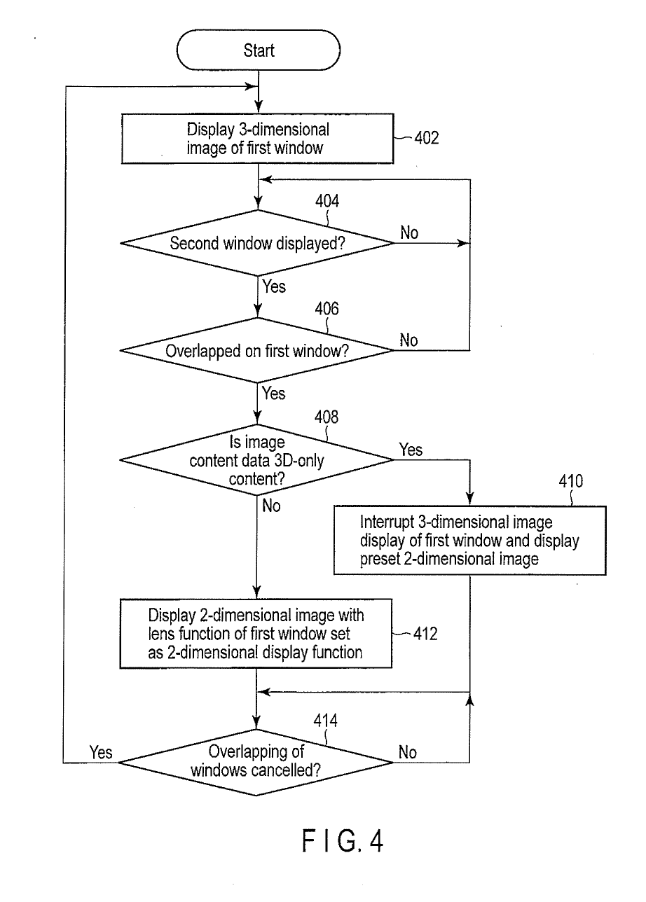

Next, the process of the image content reproduce program 13B if another window overlaps a three-dimensional image display window is explained with reference to the flowchart of FIG. 4.

By the process described above, the reproduce program 13B displays a three-dimensional image in the three-dimensional image display mode at block 402. That is, the image display module 36 supplies three-dimensional image data to a region (first window) specified in the LCD 15A. The 2D/3D mode switching module 38 supplies an electrode drive signal that controls a portion of the lens unit 15B corresponding to the first window to have a lens function (refractive index) required for three-dimensional display to the lens unit 15B. Therefore, the refractive indices are controlled to cause lights from the respective pixels to be emitted in various directions.

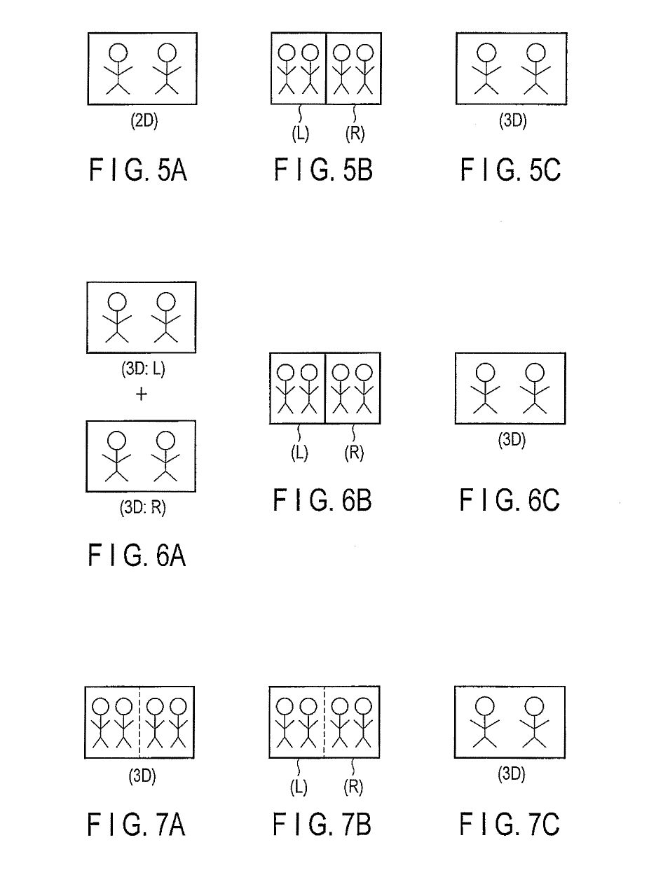

When read image content is three-dimensional image data (FIG. 5A), the image processor module 34 subjects the two-dimensional image data to 2D-3D conversion to create left-eye and right-eye image data items and supplies three-dimensional image (parallax image) data (FIG. 5B) configured by arranging left-eye and right-eye image data items in the horizontal direction to the first window of the LCD 15A. As a result, a three-dimensional image (FIG. 5C) is displayed in the first window.

When read image content is three-dimensional image data (FIG. 6A) configured by a stream (L) of left-eye image data and a stream (R) of right-eye image data, the image processor module 34 supplies three-dimensional image (parallax image) data (FIG. 6B) configured by arranging left-eye and right-eye image data items in the horizontal direction to the first window of the LCD 15A. As a result, a three-dimensional image (FIG. 6C) is displayed in the first window.

When read image content is three-dimensional image (parallax image) data (one stream) of one frame (FIG. 7A) having respective frames of left-eye image data and right-eye image data arranged in the horizontal direction, the image processor module 34 supplies the data as it is (FIG. 7B) to the first window of the LCD 15A. As a result, a three-dimensional image (FIG. 7C) is displayed in the first window.

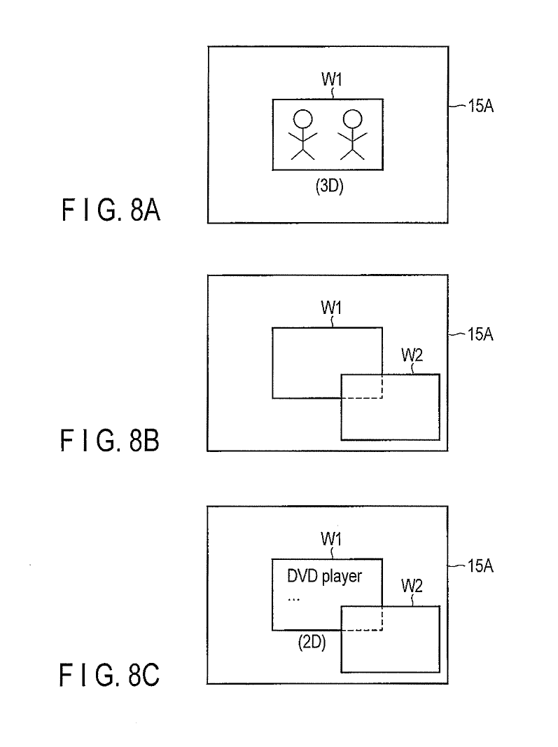

In either case, a three-dimensional image is displayed in first window W1 (FIG. 8A) in the LCD 15A by the process of block 402 and the user can stereoscopically view the image.

The reproduce program 13B determines at block 404 whether or not another window (second window) is displayed. The second window includes a menu screen of the reproduce program and a screen of another application program.

When the second window is displayed, the reproduce program 13B determines at block 406 whether or not second window W2 overlaps at least part of first window W1 (FIG. 8B). If second window W2 overlaps at least part of first window W1 and second window W2 is active, display of first window W1 is lost and the left-eye and right-eye images are partly eliminated. In this case, a stereoscopic image cannot be viewed.

If it is detected at block 406 that overlapping of the two windows is detected and second window W2 is active, the reproduce program 13B determines at block 408 whether or not image content is 3D-only content. If image content is 3D-only content, the three-dimensional display mode of first window W1 is stopped (FIG. 8C) at block 410 and a preset two-dimensional image is displayed instead. The image content (FIG. 6A) includes 3D-only content and three-dimensional content (different from the 3D-only content).

In some optical disks that store three-dimensional image data, only three-dimensional display of images that can be stereoscopically viewed is permitted and display of other images is inhibited. In such an optical disk, specification information of “3D-only” is also stored and data stored in the above optical disk is 3D-only content. It is determined at block 408 whether or not “3D-only” specification information is included in image content data read from the optical disk.

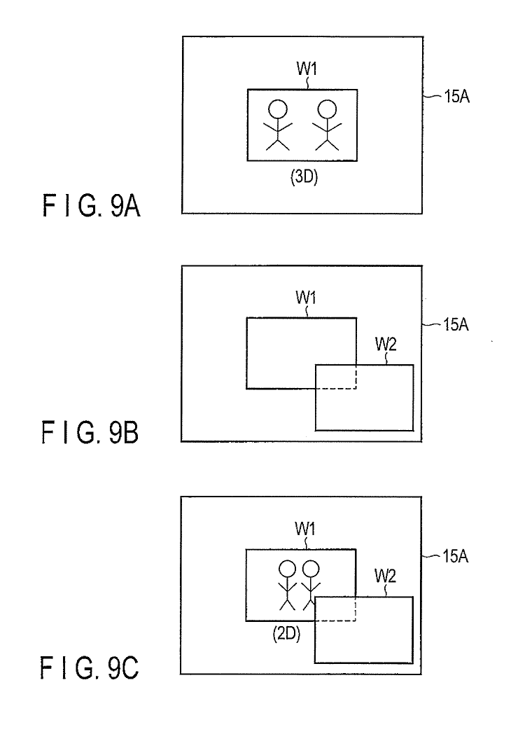

Therefore, supply of image content to the LCD 15A is stopped at block 410 to interrupt three-dimensional image display of first window W1 since display of 3D-only content is inhibited (FIG. 8B). The state may be kept unchanged, but a preset two-dimensional image, for example, a logo mark of a reproduce program (FIG. 8C) may be displayed to reduce an unnatural feeling that first window W1 becomes completely dark. In this case, the 2D/3D switching module 38 supplies an electrode drive signal that controls a portion of the lens unit 15B corresponding to first window W1 to have a lens function (refractive index) required for two-dimensional display to the lens unit 15B. At block 410, not only is a preset two-dimensional image displayed, but also a three-dimensional image (parallax image) (FIG. 6B) may be supplied to the first window of the LCD 15A. In this case, since the lens unit 15B does not have a lens function (refractive index) required for three-dimensional display, an image is displayed as an image with the horizontal width narrowed (FIG. 9C). At this time, the display mode of second window W2 that is active may be a two-dimensional display mode or three-dimensional display mode.

It is not necessary to perform block 410 if second window W2 overlaps at least part of first window W1 since left-eye and right-eye images of first window W1 are not eliminated if first window W1 is active.

After block 410, the reproduce program 13B determines at block 414 whether overlapping of the two windows is cancelled or not. Since the sizes and positions of windows W1, W2 are freely changed, the user may perform an operation to cancel, the overlapping while viewing the display image (FIG. 8C or FIG. 9C). The process at block 414 waits until the overlapping is cancelled and when the overlapping is cancelled, the process returns to block 402 and three-dimensional display of a three-dimensional image is restarted in first window W1. In this case, in order to restart three-dimensional display of a three-dimensional image from an interrupted position (FIG. 8B), the interrupted position may be stored when the three-dimensional display of the three-dimensional image is interrupted at block 410.

If image content is not 3D-only content, the image processor module 34 sets back first window W1 to the two-dimensional display mode at block 412. The content that is not 3D-only content includes three-dimensional image content obtained by subjecting two-dimensional image data to 2D-3D conversion as shown in FIGS. 5A-5C, three-dimensional image content (other than 3D-only content) shown in FIGS. 6A-6C or three-dimensional image content shown in FIGS. 7A-7C. The 2D/3D mode switching module 38 supplies an electrode drive signal that controls a portion of the lens unit 15B corresponding to first window W1 to have a lens function (refractive index) required for two-dimensional display to the lens unit 15B. Thus, since the portion of the lens unit 15B corresponding to first window W1 is controlled to have a lens function required for two-dimensional display, lights from respective pixels of the LCD 15A are not emitted in multiple directions. Therefore, data supplied to first window W1 by means of the image display module 36 may be two-dimensional image data or three-dimensional image data. That is, the image display module 36 supplies data including two-dimensional image data (FIG. 5A), three-dimensional image data (FIG. 5B), one of left-eye and right eye image data items (image data free from parallax) (FIG. 6A), parallax image data (FIG. 6B) or parallax image data (FIGS. 7(a) or (b)). As a result, three-dimensional display of a three-dimensional image of first window W1 is interrupted (FIG. 8C) and two-dimensional display of a two-dimensional image corresponding to the three-dimensional image having been displayed so far is started. When three-dimensional image data items (FIG. 6B or FIG. 7A or FIG. 7B) are displayed in first window W1, a state in which an image is compressed in the horizontal direction and displayed (FIG. 8C) is obtained since the lens unit 15B does not have a refractive-index function. When two-dimensional image data (FIG. 5A) or one of left-eye and right eye image data items (image data free from parallax) (FIG. 6A) is displayed, the display image will not be compressed in the horizontal direction.

The determination process at block 414 is performed after block 412 and if the overlapping is cancelled, the process returns to block 402 and three-dimensional display of a three-dimensional image is restarted in window W1.

As described above, according to this embodiment, when a three-dimensional image is displayed in a three-dimensional display fashion in the window of a display in which three-dimensional display and two-dimensional display can be partially made, the three-dimensional display of the three-dimensional image in the above window is interrupted if overlapping of another window is detected. As a result, it is prevented that a stereoscopic image of the window is destroyed by overlapping of the other window and a meaningless image or an image with an unpleasant feeling or unnatural feeling is displayed. Thus, content can be continuously viewed although they are two-dimensional and it is preferable for the user by displaying a two-dimensional image corresponding to the three-dimensional image that is interrupted from being displayed in the window instead of interruption of the three-dimensional display. Further, if the user cancels the overlapping by changing the position and size of the other window, three-dimensional display of the original three-dimensional image can be recovered and the convenience of the user can be enhanced.

The various modules of the systems described herein can be implemented as software applications, hardware and/or software modules, or components on one or more computers, such as servers. While the various modules are illustrated separately, they may share some or all of the same underlying logic or code. Since the image reproduce procedure of this embodiment can be performed by software, the same effect as that of this embodiment can be easily realized simply by installing a program that performs the image reproduce procedure in a normal computer and executing the program via a computer-readable storage medium that stores the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display module configured to three-dimensionally display an image in a first region of a display screen and to display information in a second region of the display screen, the display screen capable to switch two-dimensional display and three-dimensional display;
a detector configured to detect overlapping between at least part of the first region and the second region; and
a display controller configured to two-dimensionally display the image in the first region if the detector detects the overlapping.

2. The apparatus of claim 1, wherein the display controller is configured to determine a type of an image to be displayed in the first region and to control display of the first region according to the determined type of the image.

3. The apparatus of claim 2, wherein the display controller is configured to interrupt the display of the first region if the determined type of the image to be displayed in the first region is an image limited to three-dimensional display.

4. The apparatus of claim 1, wherein the display controller is configured to two-dimensionally display a two-dimensional image in the first region, the two-dimensional image corresponding to the three-dimensional image that has been three-dimensionally displayed in the first region if the detector detects the overlapping.

5. The apparatus of claim 4, wherein the display controller is configured to two-dimensionally display an image that has been three-dimensionally displayed in the first region if the detector detects the overlapping.

6. The apparatus of claim 4, wherein the display controller is configured to two-dimensionally display one of left-eye and right-eye images in the first region, the left-eye and right-eye images configuring the three-dimensional image that has been three-dimensionally displayed in the first region if the detector detects the overlapping.

7. The apparatus of claim 1, wherein the display controller is configured to two-dimensionally display preset information in the first region if the detector detects the overlapping.

8. The apparatus of claim 1,
wherein the detector if further configured to detect cancellation of the overlapping, and
wherein the display controller is configured to restart three-dimensional display in the first region if the detector detects the cancellation of the overlapping.

9. An information processing method comprising:
three-dimensionally displaying an image in a first region of a display screen and displaying information in a second region of the display screen, the display screen capable to switch two-dimensional display and three-dimensional display;
detecting overlapping between at least part of the first region and the second region; and
two-dimensionally displaying the image in the first region if the overlapping is detected.

10. A non-transitory computer-readable storage medium storing computer-executable instructions that, when executed, cause a computer to:
three-dimensionally display an image in a first region of a display screen and display information in a second region of the display screen, the display screen capable to switch two-dimensional display and three-dimensional display;
detect overlapping between at least part of the first region and the second region; and
two-dimensionally display the image in the first region if the overlapping is detected.
